(19) United States
(12) Patent Application Publication
(10) Pub. No.: US 2005/0258653 A1
(43) Pub. Date: Nov. 24, 2005

(54) Concealed fixing for track sections

(76) Inventor: Kenneth Jacobs, Guildford (GB)

Correspondence Address: PILLSBURY WINTHROP SHAW PITTMAN, LLP, P.O. BOX 10500, MCLEAN, VA, 22102, US

(21) Appl. No.: 11/062,748

(22) Filed: Feb. 23, 2005

Related U.S. Application Data
(60) Provisional application No. 60/547,425, filed on Feb. 26, 2004.

(51) Int. Cl. E05C 17/36

(52) U.S. Cl. 292/264

(57) ABSTRACT

A concealed mounting assembly for a sliding door includes mounting brackets that are first secured to a substrate. Top and bottom sliding door tracks are then press fit onto the mounting brackets to secure the tracks to the substrate. The tracks and mounting brackets have complementary contoured surfaces that engage each other when the tracks are press fit on to the mounting brackets. Once installed, the mounting brackets are concealed between the tracks and the substrate.

### CROSS REFERENCE TO RELATED APPLICATION

This application claims priority to U.S. Provisional Application No. 60/547,425, filed Feb. 26, 2004, the entire contents of which are incorporated by reference.

### BACKGROUND OF THE INVENTION

1. Field of the Invention

This invention relates to mechanisms for attaching elongated objects to mounting surfaces. In particular, the present invention relates to a concealed mechanism for mounting a track section for sliding doors.

2. Description of Related Art

Sliding panel doors, such as those used in closets, are constructed from thin panels that gain rigidity from the application of a perimeter frame formed by two side, one top, and one bottom roll formed or extruded metal sections that are mechanically joined at each corner by means of a metal or plastic joining bracket. The weight of the panel door is typically supported by a bottom track, and the door is provided with wheels or other slidable elements that can slide or roll within the bottom track. The top portion of the door is often retained and guided in a top “E” section track, which provides downwardly depending leg portions defining vertical surfaces in which the upper portion of the panel door is retained and guided. One such conventional sliding door is disclosed in U.S. Pat. No. 6,449,906, which is hereby incorporated by reference in its entirety.

The bottom and top track sections are typically mounted to mounting substrates (e.g., the floor and ceiling) using screws that extend through the tracks and into the mounting substrate. Unfortunately, the heads of the screws remain exposed and are unsightly. Furthermore, if the screw is not properly installed, it may extend into the channel in the track section and interfere with the movement of the sliding door within the channel.

### SUMMARY OF THE INVENTION

Accordingly, one aspect of one or more embodiments of this invention provides a concealed mounting assembly for mounting objects such as sliding door tracks to substrates.

The attachment mechanism is preferably concealed between the object and the substrate to provide an attractive outward appearance.

Another aspect of one or more embodiments of this invention provides a concealed mounting assembly for mounting an object to a substrate. The assembly includes at least one mounting bracket adapted to be secured to the substrate. Each mounting bracket has at least one outer surface with an outer surface profile. The assembly also includes an elongated object adapted to be secured to the mounting bracket. The elongated object has an elongated channel formed therein. The elongated channel has a pair of opposing sides, each of which have a profile that is complementary to the outer surface profile of the at least one mounting bracket. The outer surface flexes to engage the opposing sides of the elongated object.

According to a further aspect of one or more embodiments of this invention, each mounting bracket includes a peripheral slot spaced from the outer surface. The peripheral slot permits the outer surface to flex to engage the opposing sides of the elongated object.

According to a further aspect of one or more embodiments of this invention, the at least one outer surface comprises two opposing outer surfaces. The at least one mounting bracket comprises two flanges that protrude from the mounting bracket and each define one of the two outer surfaces. The flanges comprise a resilient material that enables the outer surfaces of the flanges to deflect inwardly toward each other.

According to a further aspect of one or more embodiments of this invention, the at least one mounting bracket is concealed between the object and the substrate when the mounting bracket is mounted to the object and substrate. The at least one mounting bracket may include a plurality of mounting brackets that are spaced from each other in the elongated direction of the object.

According to a further aspect of one or more embodiments of this invention, the at least one mounting bracket is disc shaped such that a circumferential edge of the mounting bracket defines the at least one outer surface. The at least one mounting bracket may have an annular flange that protrudes axially from the at least one mounting bracket. The flange defines the outer circumferential edge of the at least one mounting bracket. The annular flange comprises a resilient material that enables the outer circumferential edge to resiliently deflect in a radial direction.

According to a further aspect of one or more embodiments of this invention, the at least one mounting bracket has an elongated through slot. The assembly further includes a screw adapted to extend through the slot and into the substrate to secure the at least one mounting bracket to the substrate. The slot enables the at least one mounting bracket to be adjustably secured to the substrate.

According to a further aspect of one or more embodiments of this invention, the outer surface of the at least one mounting bracket is one of concave and convex, and the opposing sides of the object are the other of concave and convex.

According to a further aspect of one or more embodiments of this invention, the mounting bracket is adapted to be secured to the substrate before being engaged to the object.

According to a further aspect of one or more embodiments of the present invention, the elongated object is at least one elongated sliding door track. The at least one mounting bracket may include a plurality of mounting brackets that are spaced from each other in the elongated direction of the at least one elongated sliding door track. The at least one elongated sliding door track may include a top sliding door track and/or a bottom sliding door track. The at least one elongated sliding door track may include two elongated door running channels such that opposing portions of the two elongated running channels define the opposing sides of the elongated mounting channel.

Additional and/or alternative advantages and salient features of embodiments of the invention will become apparent from the following detailed description, which, taken in conjunction with the annexed drawings, disclose preferred embodiments of the invention.

### BRIEF DESCRIPTION OF THE DRAWINGS

Referring now to the drawings, which from a part of this disclosure:

FIG. 1 is a partial cross-sectional view of a sliding door mounting assembly according to one embodiment of the present invention;

FIG. 2A is a top view of a mounting bracket for the sliding door mounting assembly of FIG. 1;

FIG. 2B is a cross-sectional view of the mounting bracket in FIG. 2A, as viewed along the line 2B-2B in FIG. 2A;

FIG. 2C is a partial detail view of FIG. 2B;

FIG. 2D is a perspective view of the mounting bracket in FIG. 2A;

FIG. 3 is a cross-sectional view of top and bottom tracks according to an alternative embodiment of the present invention; and

FIG. 4 is a perspective view of a mounting bracket according to an alternative embodiment of the present invention.

### DETAILED DESCRIPTION OF PREFERRED EMBODIMENTS

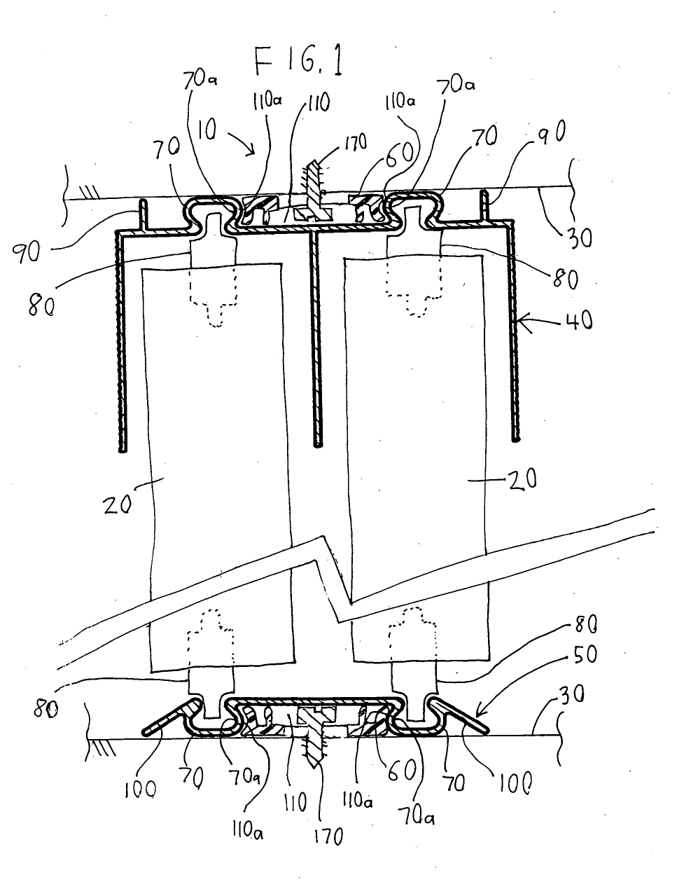

FIG. 1 illustrates a concealed mounting assembly 10 for mounting one or more sliding doors 20 to a substrate 30. The substrate 30 may include a ceiling, a floor, walls, etc. of a house or other structure. The concealed mounting assembly 10 includes a top sliding door track 40, a bottom sliding door track 50, and a plurality of mounting brackets 60 that secure the top and bottom tracks 40, 50 to the substrate 30.

The top and bottom tracks 40, 50 are elongated structures that have the cross-section illustrated in FIG. 1. Each track 40, 50 has one or more elongated running channels 70 that are designed to accommodate and guide guide wheels 80 (or other sliding elements) that are mounted to the sliding doors 20. As shown, a pair of elongated door running channels 70 are provided. It is contemplated that three or more channels 70 can be provided in each track 40, 50, depending on the number of sliding doors 20. The running channels 70 abut the substrate 30 to support the tracks 40, 50 against the substrate 30. The tracks 40, 50 also include legs 90, 100 that protrude from the tracks 40, 50, respectively, to the substrate 30 to provide additional support between the substrate 30 and the tracks 40, 50.

Opposing (or facing) portions 70a of the channels 70 define opposing sides 110a of a mounting channel 110 in each track 40, 50. Profiles of the opposing sides 10a of the channel 110 are convex.

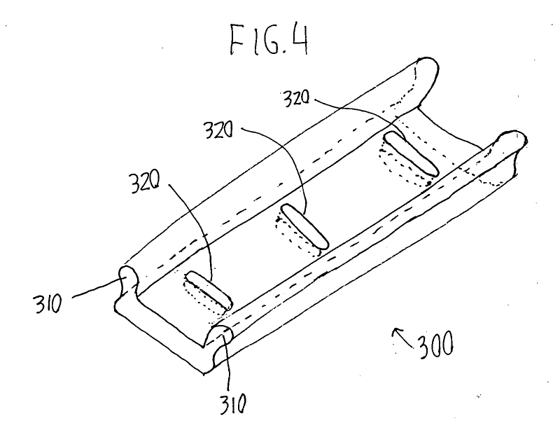

As shown in FIG. 1, the illustrated top and bottom tracks 40, 50 comprise an extruded material such as aluminum or plastic. Alternatively, as illustrated in FIG. 3, top and bottom tracks 240, 250 may comprise folded sheet metal or any other suitable material. Furthermore, the tracks 40, 50 may have a variety of other cross-sectional shapes without deviating from the scope of the present invention.

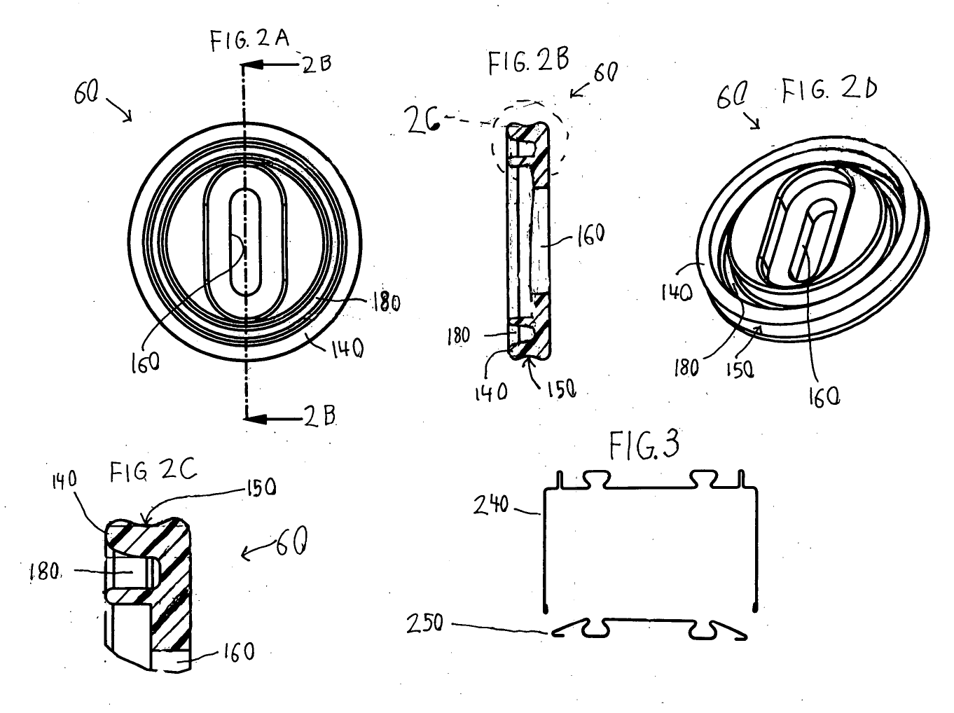

As shown in FIGS. 1 and 2A-2D, each mounting bracket 60 comprises a disc. An annular flange 140 extends in an axial direction from the mounting bracket 60 at an outer portion of the mounting bracket 60. An outer circumferential edge 150 of the flange 140 defines an outer surface that has a concave profile. The flange 140 comprises a resilient material that enables it to resiliently deflect radially inwardly and outwardly so that diametrically opposed portions of the circumferential edge 150 can deflect toward and away from each other.

The mounting bracket 60 preferably comprises plastic, but may alternatively comprise a variety of other resilient materials such as hard rubber or a combination of materials.

The concave shape of the circumferential edge 150 complements the convex opposing sides 10a of the mounting channel 110 formed in the tracks 40, 50. When the tracks 40, 50 are press fit against the mounting bracket 60, the flange 140 deflects inwardly until the channel 110 can slide over the flange 140. The flange 140 then returns to its original position such that its outer circumferential edge 150 engages the opposing sides 11a of the mounting channel 110 to secure the track 40, 50 to the mounting bracket 60.

While the illustrated mounting bracket 60 and channel 110 have complementary convex and concave surfaces, a variety of other complementary shapes may alternatively be used without deviating from the scope of the present invention. For example, the convex surface may be formed on the mounting bracket while the concave surface may be formed on the channel. Alternatively, the bracket and channel may include mating ramped teeth or other combinations of complementary protrusions, extrusions, grooves, or other profiles that engage each other to secure the mounting bracket to the track.

As shown in FIGS. 2A and 2D, an elongated through slot 160 extends across an inner portion of the mounting bracket 60. As shown in FIG. 1, the slot 160 accommodates a screw 170 that extends through the slot into the substrate 30 to secure the mounting bracket 60 to the substrate 30. As shown in FIG. 1, the slot 160 is countersunk so that a head of the screw 170 does not interfere with the tracks 40, 50. The slot 160 allows the position of the mounting bracket 60 relative to the substrate 30 to be adjusted after the screw 170 is partially tightened. The screw 170 can then be fully tightened to rigidly secure the mounting bracket 60 to the substrate 30.

A peripheral slot 180 is formed between the flange 140 and the structure that defines the slot 160. The peripheral slot 180 allows the flange 140 to deflect into the area occupied by the slot 180.

To mount the sliding door assembly 10 to the substrate 30, a plurality of mounting brackets 60 are first screwed to the substrate 30 in a spaced arrangement that follows the moving direction of the sliding doors 20. A line of spaced mounting brackets 60 are secured to the top and bottom of the substrate 30. Before fully tightening the screws 170, the mounting brackets 60 may be slid along their slots 160, which are preferably oriented in a direction that is perpendicular to the direction of travel of the doors 20, to precisely position the mounting brackets 60 in a row along the intended sliding direction of the sliding doors 20. The tracks 40, 50 are then press fit on to the mounting brackets 60 to secure the tracks 40, 50 to the substrate 30. The sliding doors 20 may then be mounted to the tracks 20 in a conventional manner. When the sliding door mounting assembly 10 is fully installed, the mounting brackets 60 and screws 170 are concealed between the substrate 30 and their respective tracks 40, 50.

The sliding door assembly 10 may be uninstalled by first removing the sliding doors 20. The tracks 40, 50 can then be pulled away from the mounting brackets 60. Finally, the mounting brackets 60 can be unscrewed from the substrate 30. The flanges 140 of the mounting brackets 60 are preferably resilient enough to allow the tracks 40, 50 to be press fit onto the mounting brackets 60, but also rigid enough to securely hold the tracks 40, 50 to the substrate 30 once installed.

While the illustrated mounting brackets 60 are circular disc shaped, mounting brackets according to the present invention may alternatively form a variety of other shapes. For example, the mounting brackets may have elliptical disc shapes. Alternatively, as shown in FIG. 4, a mounting bracket 300 may be rectangular and have two discrete, linear, parallel flanges 310 on opposing sides of the rectangle. The mounting bracket 300 has a cross-sectional shape that is similar to the cross-sectional shape of the mounting bracket 60 as illustrated in FIGS. 2B and 2C. A single, elongated, rectangular mounting bracket 300 may be used for each track 40, 50. The bracket 300 preferably has about the same length as its corresponding track 40, 50. Alternatively, a plurality of smaller spaced mounting brackets 300 may be used, as in the previously described embodiment. Mounting slots 320 similar to the slots 160 are arranged in a spaced relationship along the mounting bracket 300. Each slot 320 extends in a direction that is perpendicular to the elongated direction of the mounting bracket 300. The mounting bracket 300 comprises an extruded material but may alternatively comprise a variety of other suitable resilient materials such as molded plastic.

The foregoing description is included to illustrate the operation of the preferred embodiments and is not meant to limit the scope of the invention. To the contrary, those skilled in the art should appreciate that varieties may be constructed and employed without departing from the scope of the invention, aspects of which are recited by the claims appended hereto. For example, the concealed mounting assembly may be used with objects other than sliding door tracks. Specifically, the above-described concealed mounting assembly may be used in any suitable application where an object is to be discretely and attractively secured to a substrate.

1. A concealed mounting assembly for mounting an object to a substrate, the assembly comprising:
at least one mounting bracket adapted to be secured to the substrate, wherein each mounting bracket has at least one outer surface, wherein each of the at least one outer surface has a profile; and
an elongated object adapted to be secured to the mounting bracket, wherein the elongated object has an elongated channel formed therein, wherein the elongated channel has a pair of opposing sides, wherein each of the opposing sides has a profile that is complementary to the profile of the at least one outer surface, wherein the at least one outer surface flexes to engage the opposing sides of the elongated object.

2. The assembly of claim 1, wherein each mounting bracket includes a peripheral slot spaced from the at least one outer surface, wherein the peripheral slot permits the at least one outer surface to flex to engage the opposing sides of the elongated object.

3. The assembly of claim 1, wherein the at least one outer surface comprises two opposing outer surfaces, wherein the at least one mounting bracket comprises two flanges that protrude from the mounting bracket and each define one of the two outer surfaces, and wherein the flanges comprise a resilient material that enables the outer surfaces of the flanges to deflect inwardly toward each other.

4. The assembly of claim 1, wherein, the at least one mounting bracket is concealed between the object and the substrate when the mounting bracket is mounted to the object and substrate.

5. The assembly of claim 1, wherein the at least one mounting bracket comprises a plurality of mounting brackets that are spaced from each other in the elongated direction of the object.

6. The assembly of claim 1, wherein the at least one outer surface comprises one continuous outer surface.

7. The assembly of claim 1, wherein the at least one mounting bracket is disc shaped, and wherein a circumferential edge of the mounting bracket defines the at least one outer surface.

8. The assembly of claim 7, wherein the at least one mounting bracket has an annular flange that protrudes axially from the at least one mounting bracket, wherein the flange defines the outer circumferential edge of the at least one mounting bracket, and wherein the annular flange comprises a resilient material that enables the outer circumferential edge to resiliently deflect in a radial direction.

9. The assembly of claim 1, wherein the at least one mounting bracket has an elongated through slot, wherein the assembly further comprises a screw adapted to extend through the slot and into the substrate to secure the at least one mounting bracket to the substrate, and wherein the slot enables the at least one mounting bracket to be adjustably secured to the substrate.

10. The assembly of claim 1, wherein the at least one outer surface of the at least one mounting bracket is one of concave and convex, and wherein the opposing sides of the object are the other of concave and convex.

11. The assembly of claim 1, wherein the mounting bracket is adapted to be secured to the substrate before being engaged to the object.

12. A concealed mounting assembly for mounting a sliding door to a substrate, the assembly comprising:
at least one mounting bracket adapted to be secured to the substrate, wherein each mounting bracket has at least one outer surface, wherein each of the at least one outer surface has a profile; and
at least one elongated sliding door track adapted to be secured to the mounting bracket, wherein the sliding door track has an elongated mounting channel formed therein, wherein the elongated channel has a pair of opposing sides, wherein each of the opposing sides has a profile that is complementary to the profile of the at least one outer surface, and wherein the at least one outer surface flexes to engage the opposing sides of the at least one elongated sliding door track.

13. The assembly of claim 12, wherein, the at least one mounting bracket is concealed between the at least one elongated sliding door track and the substrate when the mounting bracket is mounted to the at least one elongated sliding door track and the substrate.

14. The assembly of claim 12, wherein the at least one mounting bracket comprises a plurality of mounting brackets that are spaced from each other in the elongated direction of the at least one elongated sliding door track.

15. The assembly of claim 14, wherein the at least one elongated sliding door track comprises a top sliding door track and a bottom sliding door track.

16. The assembly of claim 12, wherein the at least one elongated sliding door track comprises two elongated door running channels, and wherein opposing portions of the two elongated running channels define the opposing sides of the elongated mounting channel.

17. The assembly of claim 12, wherein the at least one mounting bracket is disc shaped, and wherein a circumferential edge of the mounting bracket defines the at least one outer surface.

18. The assembly of claim 17, wherein the outer circumferential edge of the at least one mounting bracket is one of convex and concave, and the elongated opposing surfaces are the other of convex and concave.

19. The assembly of claim 12, wherein the at least one mounting bracket has an elongated through slot, wherein the assembly further comprises a screw adapted to extend through the slot and into the substrate to secure the at least one mounting bracket to the substrate, and wherein the slot enables the at least one mounting bracket to be adjustably secured to the substrate.

20. The assembly of claim 12, wherein the at least one outer surface comprises two outer surfaces, wherein the at least one mounting bracket comprises two flanges that protrude from the mounting bracket and each define one of the two outer surfaces, and wherein the flanges comprise a resilient material that enables the outer surfaces of the flanges to deflect inwardly toward each other.
